(19) United States
(12) Patent Application Publication
(10) Pub. No.: US 2010/0147662 A1
(43) Pub. Date: Jun. 17, 2010

(54) LIGHT-EMITTING KEYBOARD

(75) Inventors: Liang-Ta Yeh, Taoyuan (TW); Hsien-Tsan Chang, Taoyuan (TW)

Correspondence Address: WPAT, PC;INTELLECTUAL PROPERTY ATTORNEYS, 7225 BEVERLY ST., ANNANDALE, VA, 22003, US

(73) Assignee: Darfon Electronics Corp., Taoyuan (TW)

(21) Appl. No.: 12/640,401

(22) Filed: Dec. 17, 2009

(30) Foreign Application Priority Data
Dec. 17, 2008 (TW) 097222599

(51) Int. Cl. H01H 9/00

(52) U.S. Cl. 200/314

(57) ABSTRACT

A light-emitting keyboard is disclosed, which comprises: a support panel, having at least one first hole; a light guide plate, having at least one second hole; a reflection plate circuit assembly, including a reflection plate and a circuit; at least one light source, for projecting light to the light guide plate; at least one elastic member, each having an activating post and being disposed inside its corresponding first and second holes while enabling its bottom to abut against the reflection plate circuit assembly; a keycap, mounted on the elastic member; and a shell; wherein, the light guide plate and the reflection plate circuit assembly forms a stacking arrangement from top to bottom in series; and the bottom of the activating post in each elastic member is enabled to engage with the reflection plate circuit assembly for enabling the circuit to be electrically conducted when the keycap is being pressed.

### FIELD OF THE INVENTION

The present invention relates to a light-emitting keyboard, and more particularly, to a light-emitting keyboard with reduced thickness and also whose overall structure complexity is decreased.

### BACKGROUND OF THE INVENTION

Keyboard, being the most common input interface available on the market, is vastly used in many electric devices, such as computers, person digital assistances, cellular phones, and so on. Moreover, by adopting thin film switches in keyboard designs, the resulting keyboard is not only thinner, but also quieter while being pressed that the application of keyboard as input interface is becoming more and more popular. However, except for the keyboard to function as an input interface, there are keyboards with light emitting capability being currently available on the market that such light-emitting keyboards are provided for helping a user in a insufficiently illuminated environment to be able to press the intended press key on the keyboard without causing any erroneous inputting.

Please refer to FIG. 1, which is a schematic diagram showing a press key structure of a conventional light-emitting keyboard. In FIG. 1, the press key structure is a stacking structure that is configured with a substrate 11, a reflection plate 12, a light guide panel 13, a thin film switch 14, a shielding plate 15 and a support panel 16 being arranged stacking on top of one another from top to bottom in series; in which there is an elastic member 16 disposed on the support panel 16 that is provided for a keycap 171 to mount on top of the same; and the elastic member 16 is further configured with an activating post 172 at the bottom thereof. Furthermore, there is a scissors-type structure 18 sandwiched between the bottom of the keycap 171 and the support panel 16 while coupling to the two, and the scissor-type structure, being composed of a first supporting arm 181 and a second supporting arm 182, is configured in a manner that the two supporting arms 181, 182 are pivotally coupled with each other at the middle thereof forming an X-shaped structure while pivotally connecting their top ends to the bottom of the keycap 171 and connecting their bottom ends to the support panel 16. As shown in FIG. 1, there are hollowed areas 151, 161 being formed respectively on the shielding plate 15 and the support panel 16 at positions corresponding to the elastic members 16. By the configuration of the hollowed areas 151, 161, when the keycap 171 is pressed by a user and thus cause the elastic member 16 to be compress, the activating post 172 will be brought along to sink accordingly for allowing the activating post 172 to piece through the hollowed areas 151, 161 and thus engage with the thin film switch 14 for causing an electrical conduction. On the other hand, as there can be a light source arranged at a side of the light guide plate 13, the beam projected into the light guide plate 13 from the light source will be guided to the reflection plate 12 where it is reflected to the hollowed areas 151, 161 and out of the press key structure 10 therethrough.

From the aforesaid description, it is noted that the stacking structure of the conventional light-emitting press key structure 10 not only will cause the complexity in its manufacturing process to increase and consequently, the increase in manufacturing cost and in assemble difficulty, but also since there are two supporting arms are pivotally coupled with each other at the middle thereof forming a scissor-type structure, the keycap is elevated by a specific height for causing the conventional light-emitting keyboard having such conventional press key structures 10 received in the shell thereof to be formed with a specific thickness that can not be reduced.

### SUMMARY OF THE INVENTION

In view of the disadvantages of prior art, the primary object of the present invention is to provide a structurally simplified light-emitting keyboard with reduced thickness.

To achieve the above object, the present invention provides a light-emitting keyboard, comprising: a support panel, configured with at least one first hole; a light guide plate, configured with at least one second hole; a reflection plate circuit assembly, composed of a reflection plate and a circuit; at least one light source, each for projecting light to the light guide plate; at least one elastic member, each having an activating post and being disposed inside a corresponding first hole and second hole while enabling the bottom thereof to abut against the reflection plate circuit assembly; a keycap, mounted on top of the elastic member; and a shell for housing the aforesaid components; wherein, the light guide plate and the reflection plate circuit assembly are arranged stacking on top of one another other from top to bottom in series; and the bottom of the activating post in the at least one elastic member is enabled to engage with the reflection plate circuit assembly for enabling the circuit to be electrically conducted when the keycap is being pressed for forcing the at least one elastic member to be depressed.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a schematic diagram showing a press key structure of a conventional light-emitting keyboard.

FIG. 2 is a schematic diagram showing a press key in a light-emitting keyboard according to a first embodiment of the invention.

FIG. 3 is a schematic diagram showing a press key in a light-emitting keyboard according to a second embodiment of the invention.

FIG. 4 is a schematic diagram showing a press key in a light-emitting keyboard according to a third embodiment of the invention.

FIG. 5 is a schematic diagram showing a press key in a light-emitting keyboard according to a fourth embodiment of the invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

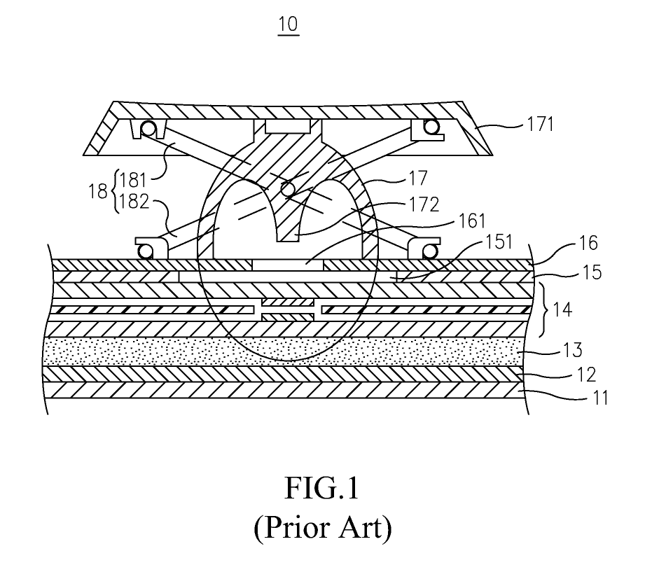

Please refer to FIG. 2, which is a schematic diagram showing a press key in a light-emitting keyboard according to a first embodiment of the invention. In FIG. 1, the press key 20 comprises: a support panel 21, configured with a first hole 211; a light guide plate 22, being disposed at the bottom of the support panel 21 and configured with a second hole 221 at a position thereof corresponding to the first hole 211; a reflection plate circuit assembly 23, disposed at the bottom of the light guide plate 22 and composed of a reflection plate 231 and a circuit 232 in a manner that the circuit 232 is formed on top of the reflection plate 231; and an elastic member 24, being disposed inside the corresponding first hole 211 and second hole 221 while enabling the bottom thereof to abut against the reflection plate circuit assembly 23. Moreover, the elastic member 24 is configured with an activating post 241 at the center thereof whereas the activating post 241 is further configured with an electric conductor at the bottom thereof. When the elastic member 24 is not being pressed, as the status shown in FIG. 2, the bottom of the electric conductor 242 will be separated from the circuit 232 by a specific distance D1 so that the electric conductor 242 is not electrically conducted with the circuit 232. In addition, there is a keycap 234 mounted on top of the elastic member 24 while there is a scissors-type structure 25 disposed under the bottom of the keycap, and the scissor-type structure 25, being composed of a first supporting arm 251 and a second supporting arm 252, is configured in a manner that the top ends of the two supporting arms 251, 252 are pivotally coupled to the bottom of the keycap 243 while connecting their bottom ends to the support panel 21. Furthermore, the press key 20 of the present embodiment further comprises a light source, which is provided for projecting a beam to the light guide plate 22 where it is guided to the reflection plate 231 for reflecting the same to the first hole 211 and second hole 221 for emission. Generally, the light source is arranged at a side of the light guide plate 22, however, it is not limited thereby and can be arranged at any location at will according to actual requirement.

It is noted that the press key 20 further includes a shell, which is provided for housing the support panel 21, the light guide plate 22, the reflection plate circuit assembly 23, the elastic member 24, the keycap 243 and the light source so as to construct a complete light-emitting keyboard. It is emphasized that although the light-emitting keyboard in the aforesaid embodiment only demonstrates one press key, the light-emitting keyboard usually contains more than one press keys of the same structure so that the light-emitting keyboard with one press key is only used for illustration and is not limited thereby.

As shown in FIG. 2, the light-emitting keyboard is characterized in that:
(1) The support panel 21 having the scissors-type structure 25 mounted thereon is designed to function as the conventional shielding plate, thereby, not only the cost and the labor required for assembling the shielding plate can be saved, but also the thickness of the overall keyboard is reduced since there is no shielding plate in the structure.
(2) By forming the second hole 221 on the light guide plate 22 for receiving the elastic member 24, the overall thickness of the keyboard is reduced by at least the thickness of the light guide plate.
(3) As the circuit 232 is formed directed on the top surface of the reflection plate 231, the reflection plate is functioned as the conventional flexible printed circuit board so that since there is no substrate required in the resulting light-emitting keyboard, not only the cost is reduced, but also the overall thickness is decreased.
(4) As the reflection plate 231 is designed to function as the conventional substrate 11 shown in FIG. 1 that is able to engage directly with the shell of the press key structure 20, not only the cost for configuring the substrate is saved, but also the overall thickness is decreased.

Comparing the press key 20 of FIG. 2 with that shown in FIG. 1, it is noted that the thickness of the press key 20 is greatly reduced so that the overall thickness of the resulting light-emitting keyboard can be effectively reduced as well. In the embodiment of FIG. 2, the electric conductor at the bottom of the activating post 241 is lowered and thus engages with the circuit 232 for enabling the circuit 232 to be electrically conducted when the keycap 243 is being pressed for depressing the elastic member 24.

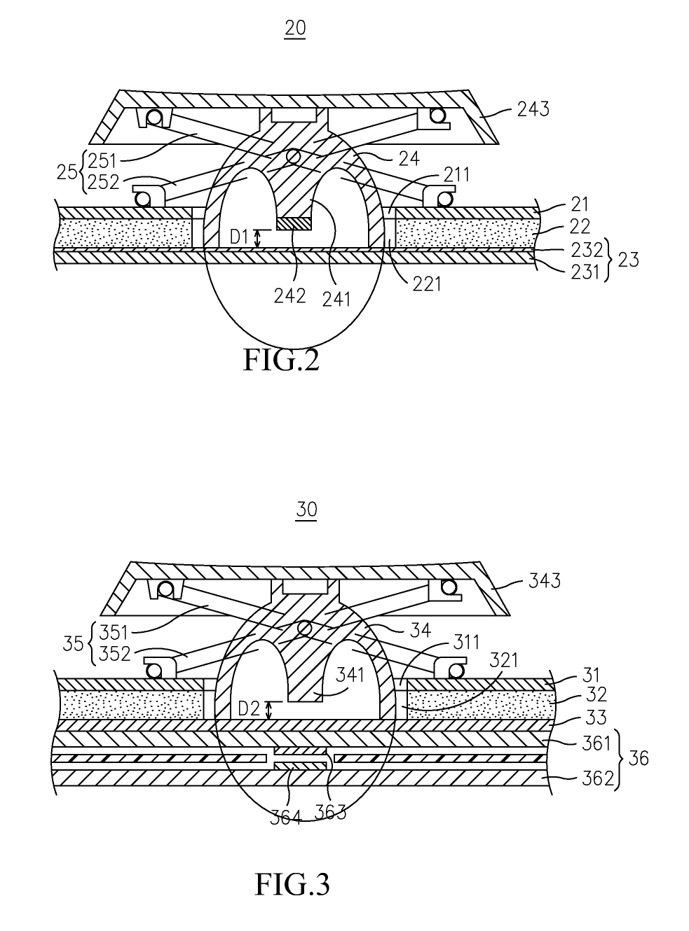

Please refer to FIG. 3, which is a schematic diagram showing a press key in a light-emitting keyboard according to a second embodiment of the invention. In FIG. 3, the press key 30 is a stacking structure composed of a support panel 31, a light guide plate 32, a reflection plate 33 form top to bottom, in which the support panel 31 is formed with a first hole 311 and the light guide plate 32 is formed with a second hole 321 whereas there is an elastic member 34 having an activating post 341 being received inside the first hole 311 and the second hole 321. When the elastic member 34 is not being pressed, as the status shown in FIG. 3, the bottom of the activating post 341 will be separated from the reflection plate 33 by a specific distance D2. In addition, there is a keycap 343 mounted on top of the elastic member 34 while there is a scissors-type structure 35 sandwiched between the keycap 343 and the support panel 31, and the scissor-type structure 35, being composed of a first supporting arm 351 and a second supporting arm 352, is configured in a manner the two supporting arms 351, 352 are pivotally coupled with each other at the middle thereof forming an X-shaped structure. The functions of the aforesaid components are similar to those shown in FIG. 2, and thus are not described further herein. The press key 30 of the present embodiment is characterized in that: there is a thin film switch 36 disposed on the bottom of the reflection plate 33, which is composed of two thin films 361, 362 having electric conductors 363, 364 arranged face to face at position corresponding to each other. Thereby, the electric conduction is constructed by the engaging of the two electric conductors 363, 364 on the two thin films 361, 362 as soon as the keycap 343 is being pressed for bringing along the activating post 341 to press on the two thin films 361, 362. It is noted that the thickness of the press key 30 in FIG. 3 might be slightly larger than that of the FIG. 2, but it is still significantly reduced comparing with the thickness of the conventional press key of FIG. 1.

Please refer to FIG. 4, which is a schematic diagram showing a press key in a light-emitting keyboard according to a third embodiment of the invention. In FIG. 4, the press key 40 includes a support panel 41, a light guide plate 42, a reflection plate 43, an elastic member 44, an activating post 441, a keycap 443, a scissor-type structure 45, which is similar to those shown in FIG. 2 and FIG. 3. The press key 40 of the present embodiment is characterized in that: there is a circuit board 43 disposed at the bottom of the reflection plate 43, which is composed of a substrate 461 and a circuit, whereas the circuit 462 is disposed on a top surface of the substrate 461. It is noted that the substrate 461 can be made of a flexible material or a rigid material. As there is a third hole 431 formed on the reflection plate 43 at a position corresponding to the activating post 441, and there is an electric conductor 442 arranged at the bottom of the activating post 441, an electric conduction will be constructed by the engaging of the electric conductor 442 and the circuit 462 as soon as the keycap 443 is being pressed for causing the activating post 441 along with the electric conductor 442 arranged at the bottom thereof to piece through the reflection plate 43 through the third hole 431 thereof. It is noted that the length of the activating post 441 can be prolonged by a proper length at will only if it is not too long for causing the bottom of electric conductor 442 to contact with the circuit 432 even when the elastic member 44 is not being depressed. From the embodiment of FIG. 4, it is noted that the architecture of the present invention is also suitable for adapting conventional printed circuit boards. Nevertheless, the thickness of the press key 40 in FIG. 4 might be slightly larger than that of the FIG. 2, but it is still significantly reduced comparing with the thickness of the conventional press key of FIG. 1.

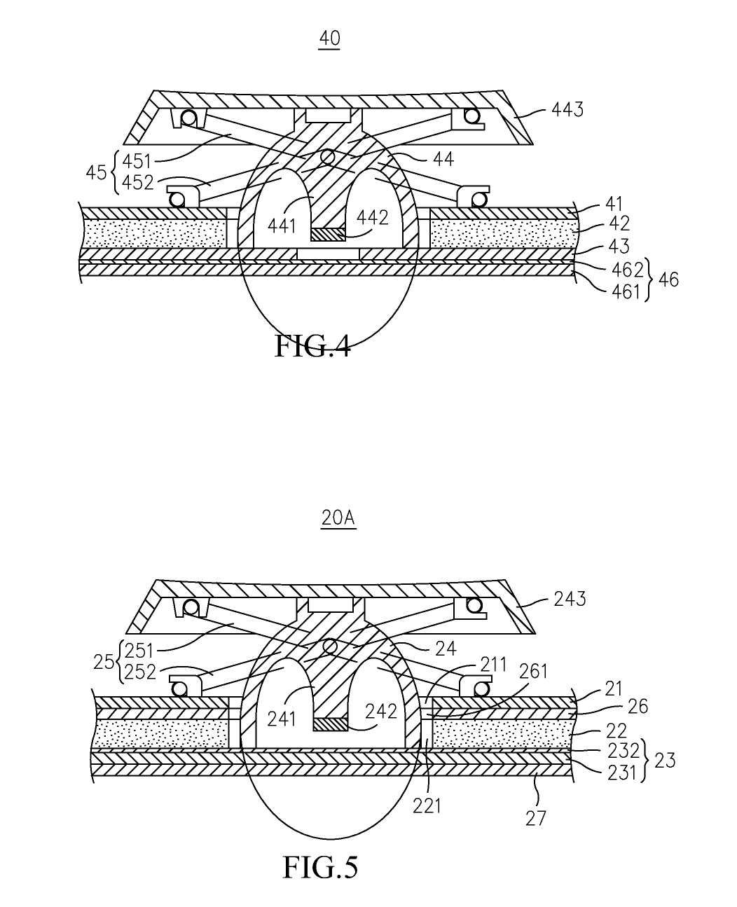

In the embodiments shown in FIG. 2 to FIG. 4, although there are support panels 21, 31, 41 having the scissors-type structure 25, 35, 45 mounted thereon, that are designed to function as the conventional shielding plate, there can still have shielding plate to be fitted therein for enhancing light shielding. Please refer to FIG. 5, which is a schematic diagram showing a press key in a light-emitting keyboard according to a fourth embodiment of the invention. The press key 20A of the present embodiment is characterized in that: there is a shielding plate 26 disposed between the support panel 21 and the light guide plate 26, whereas the shielding plate 26 is formed with a third hole 261 at a position thereof corresponding to the first hole 211 and the second hole 221 so as to receive the elastic member 24 inside the first hole 211, the second hole 221 and the third hole 261. Since there is an additional shielding plate 26, the length activating post 241 or the electric conductor 24 can be prolonged accordingly. Moreover, if there is still space available in the press key 20A, a substrate 27 can be added and attached to the bottom of the reflection plate circuit assembly 23 for improving strength. It is noted that the shielding plate 26 and the substrate 27 can also be adopted by the press keys shown in FIG. 3 and FIG. 4.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A light-emitting keyboard, comprising:
a support panel, configured with at least one first hole;
a light guide plate, disposed on a bottom of the support panel and configured with at least one second hole;
a reflection plate circuit assembly, disposed on a bottom of the light guide plate and composed of a reflection plate and a circuit;
at least one light source, each for projecting light to the light guide plate;
at least one elastic member, each having an activating post and being disposed inside its corresponding first hole and second hole while enabling the bottom thereof to abut against the reflection plate circuit assembly;
a keycap, mounted on top of the elastic member; and
a shell, for housing the support panel, the light guide plate, the reflection plate circuit assembly, the at least one light source, the at least one elastic member and the keycap;
wherein, the bottom of the activating post in the at least one elastic member is enabled to engage with the reflection plate circuit assembly for enabling the circuit to be electrically conducted when the keycap is being pressed for forcing the at least one elastic member to be depressed.

2. The light-emitting keyboard of claim 1, wherein the circuit of the reflection plate circuit assembly is formed on top of the reflection plate and there is an electric conductor arranged at the bottom of the activating post; thereby, the electric conduction is constructed by the engaging of the electric conductor and the circuit as soon as the keycap is being pressed.

3. The light-emitting keyboard of claim 1, wherein the circuit of the reflection plate circuit assembly, being substantially a thin film switch composed of two thin films respectively having electric conductors arranged face to face at positions corresponding to each other, is arranged at the bottom of the reflection plate; thereby, the electric conduction is constructed by the engaging of the two electric conductors as soon as the keycap is being pressed for bringing along the activating post to press on the two thin films.

4. The light-emitting keyboard of claim 1, wherein the circuit of the reflection plate circuit assembly is formed on a circuit board disposed on the bottom of the reflection plate while enabling the reflection plate to be configured with a third hole at a position corresponding to the activating post, and there is an electric conductor arranged at the bottom of the activating post; thereby, the electric conduction is constructed by the engaging of the electric conductor and the circuit as soon as the keycap is being pressed for causing the activating post along with the electric conductor arranged at the bottom thereof to piece through the reflection plate through the third hole thereof.

5. The light-emitting keyboard of claim 1, wherein there is a shielding plate sandwiched between the support panel and the light guide plate; and the shielding plate is configured with a fourth hole at a position thereof corresponding to the first hole and the second hole so as to enabling the at least one elastic member to be received inside the first hole, the second hole and the fourth hole.

6. The light-emitting keyboard of claim 1, wherein there is a scissors-type structure disposed under the bottom of the keycap, and the scissor-type structure, being composed of a first supporting arm and a second supporting arm, is configured in a manner that the two supporting arms are pivotally coupled with each other at about the middle section thereof while pivotally connecting their top ends of the two arms to the bottom of the keycap and connecting their bottom ends to the support panel.

7. The light-emitting keyboard of claim 1, wherein there is a substrate arranged at the bottom of the reflection plate circuit assembly.

8. The light-emitting keyboard of claim 1, wherein the at least one light source is a light emitting diode.
